(19) United States
(12) Patent Application Publication
(10) Pub. No.: US 2007/0045976 A1
(43) Pub. Date: Mar. 1, 2007

(54) Brake device for scooter

(76) Inventor: Chia-Min Wu, Syuejia Township (TW)

Correspondence Address: CHARLES E. BAXLEY, ESQ., 90 JOHN STREET, THIRD FLOOR, NEW YORK, NY, 10038, US

(21) Appl. No.: 11/219,600

(22) Filed: Sep. 1, 2005

(51) Int. Cl. B62M 1/00

(52) U.S. Cl. 280/87.041

(57) ABSTRACT

A brake device for a scooter includes a brake pedal having a stepping portion, at least one fender portion extending from at lease one side of the stepping portion, and at least one tubular member extending downward from the stepping portion. The fender portion is located above a wheel of the scooter. An elastic element mounted in the tubular member. A coupling seat is supported by a frame of the scooter and includes at least one coupling member on a top thereof. The coupling member is received in the tubular member and slidable along a vertical direction. The elastic element has a lower end abutting against a top face of the coupling member for biasing the fender portion away from the wheel. The stepping portion is pressable to move the fender portion downward to press against the wheel for braking purposes.

### BACKGROUND OF THE INVENTION

1. Field of the Invention

The present invention relates to a brake device. In particular, the present invention relates to a brake device for a scooter.

2. Description of the Related Art

Scooters are popular for they can be used as a vehicle while having fun. A typical scooter includes a brake pedal above the rear wheel of the scooter for braking purposes. FIG. 5 of the drawings illustrates a conventional brake pedal for a scooter. The brake pedal 2′ is mounted above a rear wheel 1′ of the scooter and includes a front end pivotally connected to the frame 3′. A torsion spring 4′ is mounted on the frame 3′ and includes an end 41′ for biasing the brake pedal 2′ away from the rear wheel 1′. When braking is required, the brake pedal 2′ is pressed to press against the rear wheel 1′.

However, the torsion spring 4′ is exposed and thus adversely affects the appearance of the scooter. Further, the exposed torsion spring 4′ is apt to rust. Further, the end 41′ of the torsion spring 4′ is liable to deform after a period of time, which hinders smooth operation of the brake pedal 2′.

### SUMMARY OF THE INVENTION

A brake device in accordance with the present invention is provided for a scooter having a frame and at least one wheel rotatably mounted to the frame. The brake device comprises a brake pedal that includes a stepping portion, at least one fender portion extending from at least one side of the stepping portion, and at least one tubular member extending downward from the stepping portion. The at least one fender portion is located above the at lease one wheel of the scooter.

An elastic element mounted in the at least one tubular member. A coupling seat is supported by the frame of the scooter and comprises at least one coupling member on a top thereof. The at least one coupling member is received in the at least one tubular member and slidable along a vertical direction. The elastic element has a lower end abutting against a top face of the at least one coupling member for biasing the at least one fender portion away from the at least one wheel.

The stepping portion is pressable to move the at least one fender portion downward to press against the at least one wheel for braking purposes.

Preferably, the at least one fender portion comprises a brake member on an inner face thereof for pressing against the at least one wheel for braking purposes.

Preferably, the at least one tubular member comprises a peg mounted therein. The elastic element is mounted around the peg. The at least one coupling member is tubular and comprises a longitudinal hole for slidably receiving the peg. The top face of the at least one coupling member comprises a through-hole through which the peg slidably extends.

Preferably, a fixing member is mounted to the peg. A stop is mounted between the fixing member and the peg and has a diameter greater than that of the through-hole of the at least one coupling member, preventing the at least one coupling member from disengaging from the peg.

Preferably, the coupling seat comprises at least one opening through which the frame of the scooter extends.

Preferably, the coupling seat comprises an upper base and a lower base connected with each other.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a scooter with a brake device in accordance with the present invention.

FIG. 2 is an exploded perspective view of the brake device in accordance with the present invention.

FIG. 3 is a sectional view of a rear portion of the scooter in FIG. 1.

FIG. 4 is a sectional view similar to FIG. 3, illustrating braking operation of the scooter.

FIG. 5 is a side view of a rear portion of a scooter with a conventional brake device.

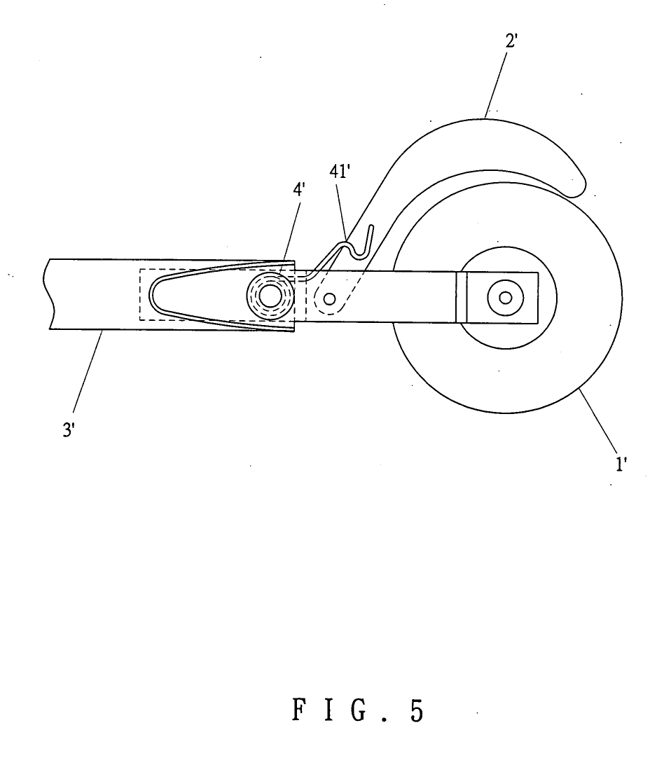

### DETAILED DESCRIPTION OF THE PREFERRED EMBODIMENT

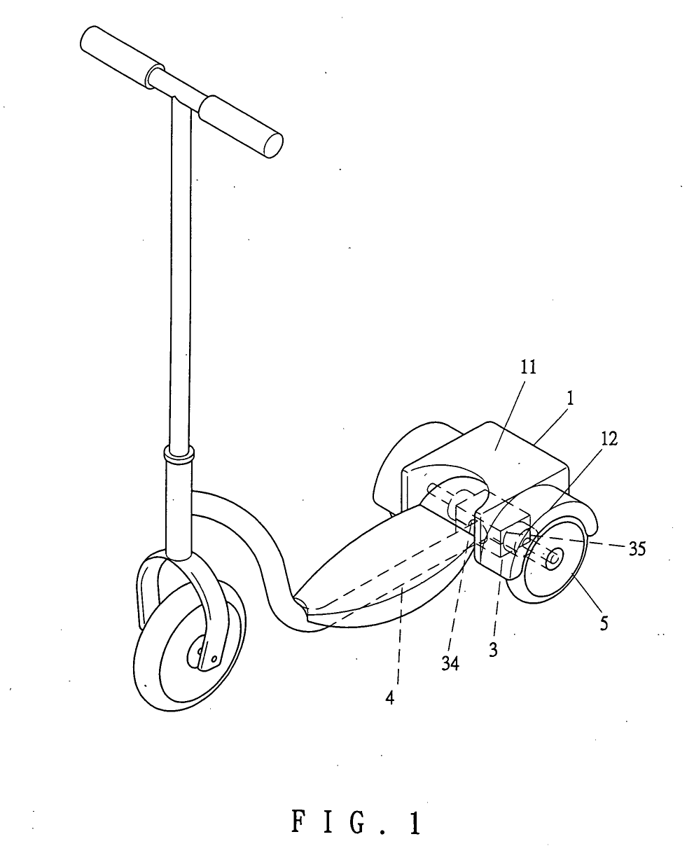

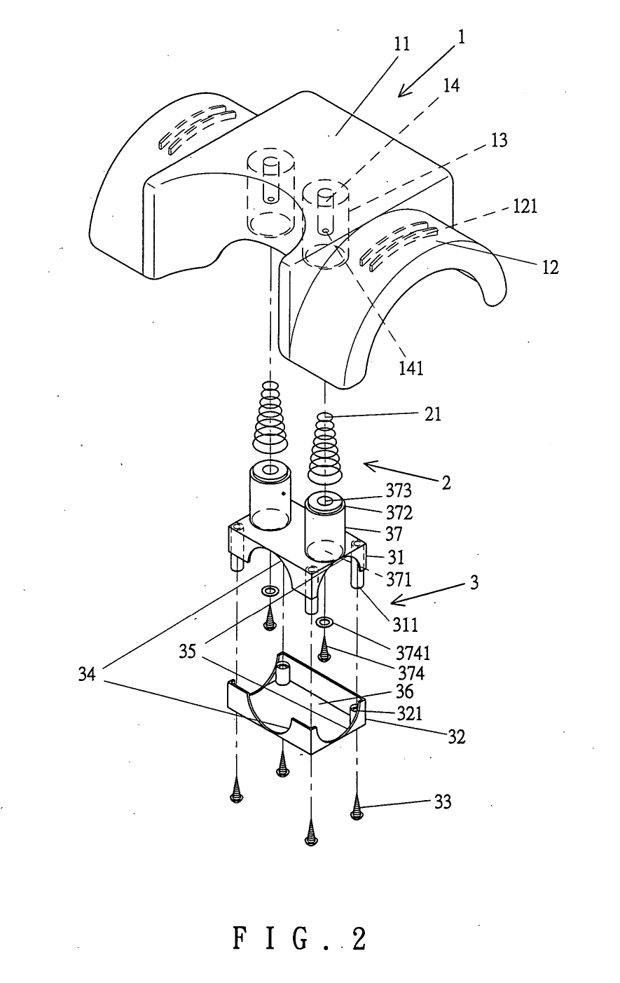

Referring to FIGS. 1 through 3, a scooter in accordance with the present invention comprises a frame 4, at least one rear wheel 5 (two in this embodiment), and a brake device. The brake device comprises a brake pedal 1, at least one elastic element 2 (two in this embodiment), and a coupling seat 3.

The brake pedal 1 comprises a stepping portion 11, at least one fender portion 12 extending outward from a side of the stepping portion 11, and at least one tubular member 13 (two in this embodiment) extending downward from the stepping portion 11. In the illustrated embodiment, two fender portions 12 respectively extend outward from left and right sides of the stepping portion 11, with each fender portion 12 including a brake member 121 on an inner face thereof. Each fender portion 12 is located above an associated wheel 5 of the scooter. Further, a peg 14 is located inside each tubular member 13 and includes a coupling hole 141.

Each elastic element 2 is preferably a compression spring and mounted in an associated tubular member 13, with a central portion 21 of each elastic element 2 mounted around an associated peg 14.

The coupling seat 3 comprises an upper base 31 and a lower base 32. The upper base 31 and the lower base 32 are connected together by fasteners 33 extending through holes 321 in the lower base 32 and holed pegs 311 of the upper base 31. The upper base 31 and the lower base 32 include openings 34 and 35 through which the frame 4 of the scooter extends. The upper base 31 and the lower base 32 further include central compartments 36.

In this embodiment, two coupling members 37 project upward from the upper base 31. Each coupling member 37 is preferably tubular and includes a longitudinal hole 371 and a top face 372. The top face 372 includes a through-hole 373 in communication with the longitudinal hole 371. Each coupling member 37 has an outer diameter slightly smaller than an inner diameter of the associated tubular member 13. The diameter of the through-hole 373 of each coupling member 37 is greater than the outer diameter of the associated peg 14. Thus, each coupling member 37 is slidably received in a space between the associated tubular member 13 and the associated peg 14, with the associated peg 14 extending through the through-hole 373 into the longitudinal hole 371. A fixing member 374 is extended through the coupling hole 141 of each peg 14 and thus fixed to the peg 14. A stop 3741 (e.g., a washer) is mounted between each fixing member 374 and the associated peg 14 and includes a diameter greater than that of the through-hole 373 of the associated coupling member 17, thereby preventing the associated coupling member 17 from disengaging from the associated tubular member 13.

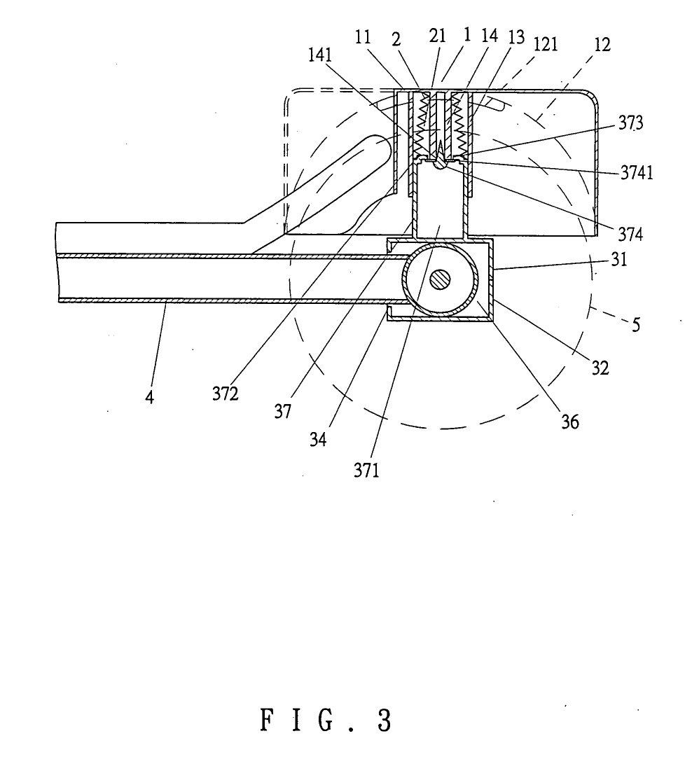

Each elastic element 2 has a lower end abutting against the top face 372 of the associated coupling member 37 and an upper end abutting against the stepping portion 11, biasing the brake member 121 of the associated fender portion 12 away from the associated wheel 5, as shown in FIG. 3.

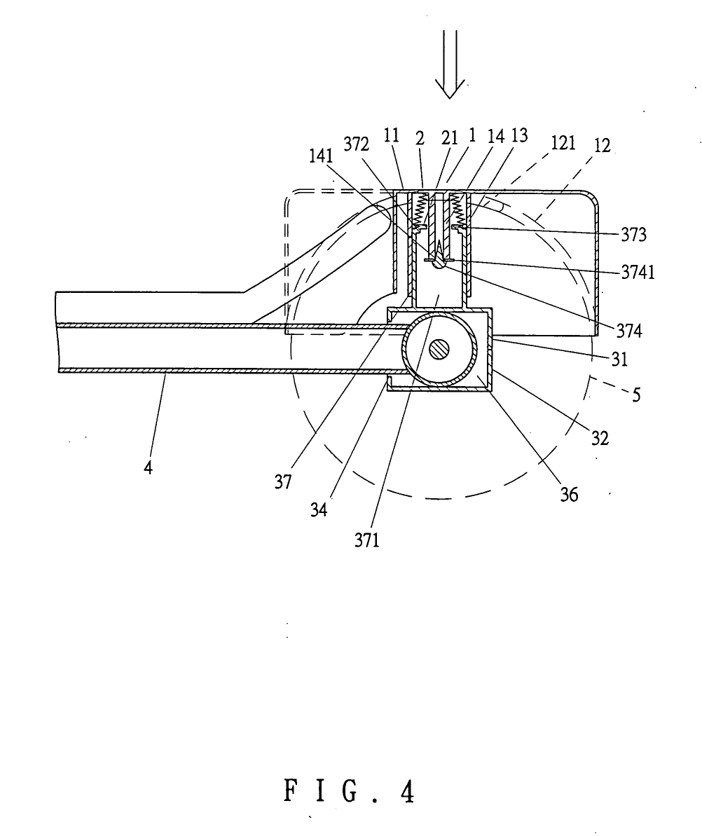

When braking is required, the stepping portion 11 is pressed, moving the braking members 121 to press against the wheels 5 for braking purposes. The tubular members 13 guide downward movement of the coupling members 37, allowing smooth braking operation, as shown in FIG. 4.

When the pressing force is removed, the brake pedal 1 is moved upward under the action of the elastic elements 2 that are compressed during braking, and the braking members 121 of the brake pedal 1 are disengaged from the wheels 5, allowing free movement of the scooter.

Since the elastic elements 2 are hidden in the pegs 4, rusting of the elastic elements 2 is less likely to occur while providing an appealing appearance. Further, the braking operation is smooth, as the coupling members 37 are guided along the vertical direction by the tubular members 13.

Although a specific embodiment has been illustrated and described, numerous modifications and variations are still possible without departing from the essence of the invention. The scope of the invention is limited by the accompanying claims.

What is claimed is:

1. A brake device for a scooter, the scooter comprising a frame and at least one wheel rotatably mounted to the frame, the brake device comprising:
a brake pedal comprising a stepping portion, at least one fender portion extending from at least one side of the stepping portion, and at least one tubular member extending downward from the stepping portion, said at least one fender portion being located above said at lease one wheel of the scooter;
an elastic element mounted in said at least one tubular member; and
a coupling seat supported by the frame of the scooter, the coupling seat comprising at least one coupling member on a top thereof, said at least one coupling member being received in said at least one tubular member and slidable along a vertical direction, said elastic element having a lower end abutting against a top face of said at least one coupling member for biasing said at least one fender portion away from said at least one wheel;
said stepping portion being pressable to move said at least one fender portion downward to press against said at least one wheel for braking purposes.

2. The brake device for a scooter as claimed in claim 1, wherein said at least one fender portion comprises a brake member on an inner face thereof for pressing against said at least one wheel for braking purposes.

3. The brake device for a scooter as claimed in claim 1, wherein said at least one tubular member comprises a peg mounted therein, said elastic element being mounted around the peg, said at least one coupling member being tubular and comprising a longitudinal hole for slidably receiving the peg, the top face of said at least one coupling member comprising a through-hole through which the peg slidably extends.

4. The brake device for a scooter as claimed in claim 3, further comprising a fixing member mounted to the peg, a stop being mounted between the fixing member and the peg and having a diameter greater than that of the through-hole of said at least one coupling member, preventing said at least one coupling member from disengaging from the peg.

5. The brake device for a scooter as claimed in claim 1, wherein the coupling seat comprises at least one opening through which the frame of the scooter extends.

6. The brake device for a scooter as claimed in claim 1, wherein the coupling seat comprises an upper base and a lower base connected with each other, each of the upper base and the lower base comprising at least one opening through which the frame of the scooter extends.
